(19) United States
(12) Patent Application Publication
(10) Pub. No.: US 2019/0073031 A1
(43) Pub. Date: Mar. 7, 2019

(54) DYNAMIC FEEDBACK SYSTEM AND METHOD FOR PROVIDING DYNAMIC FEEDBACK

(71) Applicants: DENSO International America, Inc., Southfield, MI (US); DENSO CORPORATION, Kariya-city (JP)

(72) Inventor: Michael HASLETT, Lake Orion, MI (US)

(21) Appl. No.: 15/693,614

(22) Filed: Sep. 1, 2017

(51) Int. Cl. G06F 3/01; G01B 11/16; G06F 3/044

(52) U.S. Cl. CPC G06F 3/016; G06F 3/044; G01B 11/16

(57) ABSTRACT

The present disclosure provides a dynamic feedback system for an interface device. The dynamic feedback system includes a contact surface, a speed detector, a feedback generator, and a controller. The contact surface is configured to move toward a first side of the contact surface when a pressure is exerted upon the contact surface by a user. The peed detector is configured to detect a speed of the contact surface moving toward the first side. The feedback generator is configured to provide feedback to the user. The controller is configured to control the feedback generator according to the speed of the contact surface detected by the speed detector.

### TECHNICAL FIELD

The present disclosure relates to a dynamic feedback system and a method for providing dynamic feedback to a user.

### BACKGROUND

There have been many systems utilizing feedback techniques through a variety types of mediums. One example of such feedback systems is a haptic device configured to recreate the sense of touch by applying forces, vibrations, motions, or the like, to the user. However, these haptic devices typically provide monotonous feedback to the user, which may cause the user to feel lack of reality while using the device.

In view of the above, it is an object of the present disclosure to provide a dynamic feedback system that is capable of providing more realistic feedback to the user. It is another object of the present disclosure to provide a method that is capable of providing more realistic feedback to the user.

### SUMMARY

This section provides a general summary of the disclosure, and is not a comprehensive disclosure of its full scope or all of its features.

A first aspect of the present disclosure provides a dynamic feedback system for an interface device. The dynamic feedback system includes a contact surface, a speed detector, a feedback generator, and a controller. The contact surface is configured to move toward a first side of the contact surface when a pressure is exerted upon the contact surface by a user. The peed detector is configured to detect a speed of the contact surface moving toward the first side. The feedback generator is configured to provide feedback to the user. The controller is configured to control the feedback generator according to the speed of the contact surface detected by the speed detector.

A second aspect of the present disclosure provides a method for providing dynamic feedback. The method includes moving, by a pressure exerted upon a contact surface by a user, the contact surface toward a first side of the contact surface, detecting, with a speed detector, a speed of the contact surface moving toward the first side, and controlling, with a controller, a feedback generator to provide feedback to the user according to the speed of the contract surface detected by the speed detector.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. In the drawings:

FIG. 1 is a block diagram of a dynamic feedback system according to an embodiment;

FIG. 2 is a side view of a contact surface and a solenoid of the embodiment;

FIG. 3 is a diagram exemplarily illustrating graphs of the change in voltage over time in three types of situations where the contact surface is pushed at a slow speed, a medium speed, and a fast speed;

FIG. 4 is a timing chart of the solenoid for three types of situations where the contact surface is pushed at a slow speed, a medium speed, and a fast speed; and

FIG. 5 is a flowchart of operation of the dynamic feedback system according to the embodiment.

### DETAILED DESCRIPTION

As follows, a plurality of embodiments of the present disclosure will be described with reference to drawings. It will be apparent to those skilled in the art from this disclosure that the following descriptions of the embodiments are provided for illustration only and not for the purpose of limiting the invention as defined by the appended claims and their equivalents. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts may be combined. The embodiments may be partially combined even if it is not explicitly described that the embodiments may be combined, provided there is no harm in the combination.

In the following description, a dynamic feedback system and a method for providing feedback will be described, applying the present disclosure to an interface device mounted on a vehicle. However, the present disclosure can be applied to any type of interface devices installed in PCs (Personal Computers), tablet computers, smart phones, ATMs (Automated Teller Machines), or the like.

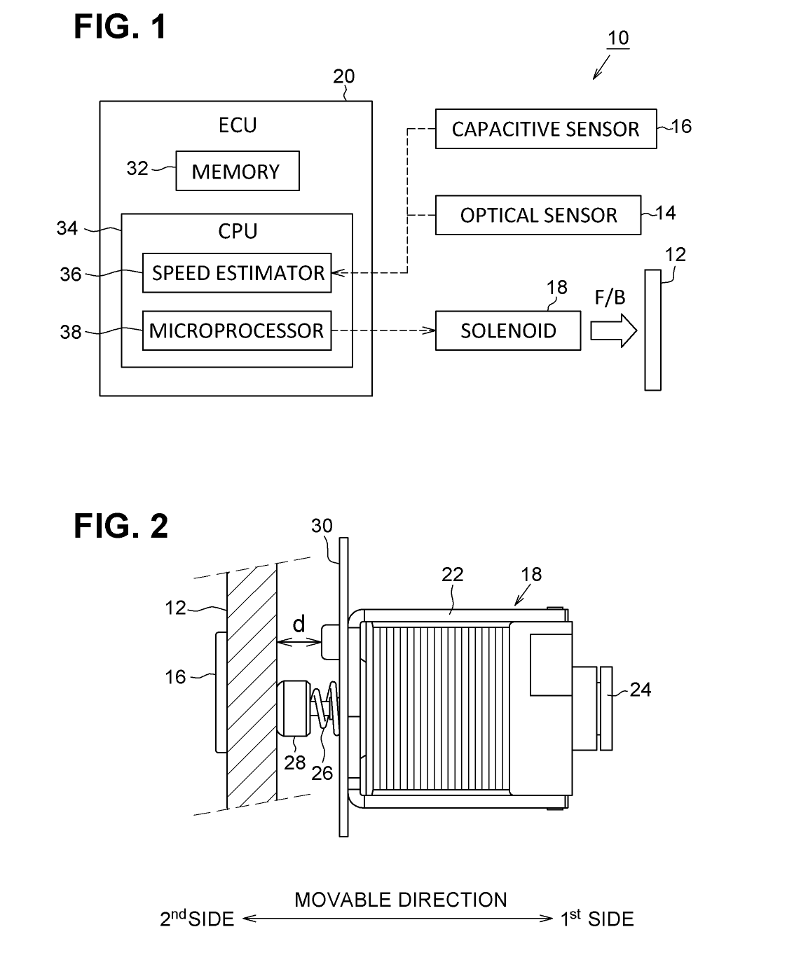

FIG. 1 is a block diagram schematically illustrating a dynamic feedback system 10. The dynamic feedback system 10 generally includes a contact surface 12, an optical sensor 14 (a speed detector, a position sensor), a capacitive sensor 16 (a touch sensor), a solenoid 18 (a feedback generator, an actuator), and an electronic control unit (ECU) 20. As described above, the dynamic feedback system 10 forms a part of the interface device that is installed in, e.g., a dash board (not illustrated) of the vehicle interior. More specifically, the dynamic feedback system 10 in this embodiment serves as a center control panel, for example, to operate electric devices such as an audio system, an air-conditioning system, and so on, for the vehicle.

The contact surface 12 is a portion of a TFT (Thin-Film-Transistor) display of the center control panel and is disposed to extend along the surface of the dash board. More specifically, the contact surface 12 serves as a push button in this embodiment. The contact surface 12 is configured to be movable along a direction (hereinafter, referred to as a “movable direction”) perpendicular to the surface of the contact surface 12 (see FIG. 2). That is, when a user (i.e., a driver or a passenger) intends to manipulate the electronic devices (e.g., turning on/off of the audio system), the contact surface 12 is touched and pushed by the user like a “push button”. Hereinafter, one side of the contact surface 12 facing the solenoid 18 is referred to as a “first side”, and the other side of the contact that is opposite to the first side is referred to as a “second side”, as shown in FIG. 2.

The capacitive sensor 16 is disposed on the contact surface 12. As shown in FIG. 1, the capacitive sensor 16 is electrically connected to the ECU 20. When a finger of a user touches the capacitive sensor 16, the capacitive sensor 16 generates a signal indicative of the contact of the user and outputs the signal to the ECU 20.

The solenoid 18 is disposed inside the dash board on the first side of the contact surface 12. The solenoid 18 generally includes a coil body 22, a plunger 24, a spring 26, and a pressing portion 28. The coil body 22 is formed of an electrically inductive coil that is wound around the plunger 24. The coil body 22 is electrically connected to a power source (not shown), energization/de-energization of which is controlled by the ECU 20.

The plunger 24 is slidably disposed inside the coil body 22 and is configured to be movable along the movable direction when the coil body 22 is energized. More specifically, when the coil body 22 is energized, the plunger 24 moves toward the second side (i.e., toward the contact surface 12 or the left side in FIG. 2). Then, when the coil body 22 is de-energized, the plunger 24 moves toward the first side (i.e., away from the contact surface 12) by a biasing force of the spring 26 as will be described below.

A side plate 30 is disposed on a side surface of the coil body 22 facing the contact surface 12. The side plate 30 is substantially in parallel with the contact surface 12. One end of the plunger 24 passes through the side plate 30 through a hole of the side plate 30. The pressing portion 28 is fixed to the one end of the plunger 24.

The spring 26 is disposed between the side plate 30 and the pressing portion 28 while surrounding the plunger 24. One end of the spring 26 is connected to the side plate 30, and the other end of the spring 26 is connected to the pressing portion 28. The spring 26 is configured to bias the pressing portion 28 toward the first side (i.e., toward the side plate 30). As a result, the pressing portion 28 is spaced away from the contact surface 12 when the coil body 22 is not energized. On the contrary, when the coil body 22 is energized and the plunger 24 moves toward the second side against the biasing force by the spring 26, the pressing portion 28 comes into contact with the contact surface 12 and presses the contact surface 12 toward the second side (i.e., away from the side plate 30 or the left side in FIG. 2).

The optical sensor 14 is attached to the side plate 30 to face the contact surface 12. In this embodiment, the optical sensor 14 is used as a position sensor to measure position of the contact surface 12. More specifically, the optical sensor 14 is configured to measure a distance d to the contact surface 12 from the optical sensor 14. The optical sensor 14 outputs a signal according to the distance d to the contact surface 12. In this embodiment, the optical sensor 14 outputs a voltage in accordance with the distance d to the contact surface 12. The value of the voltage output from the optical sensor 14 increases as the distance d to the contact surface 12 decreases. The optical sensor 14 is electrically connected to the ECU 20, and the ECU 20 inputs the signal (the voltage) from the optical sensor 14.

In the present embodiment, the ECU 20 may be formed of a memory 32 and a central processing unit (CPU) 34. It should be understood that, although the CPU 34 is described and depicted as one component in this embodiment and drawings, the CPU 34 is merely represented as a block of main functions of the ECU 20, and actual processors performing these functions may be physically separately arranged.

The memory 32 may include a random access memory (RAM) and read-only memory (ROM) and store programs therein. The programs in the memory 32 may be computer-readable, computer-executable software code containing instructions that are executed by the CPU 34. That is, the CPU 34 carries out functions by performing programs stored in the memory 32.

The CPU 34 is configured to input the signal from the capacitive sensor 16 and the voltage from the optical sensor 14 and to control the solenoid 18 (more specifically, to control energization/de-energization of the solenoid 18) according to the voltage output from the optical sensor 14. In this embodiment, the CPU may be formed of a speed estimator 36 (a speed detector) and a microprocessor 38 (a controller).

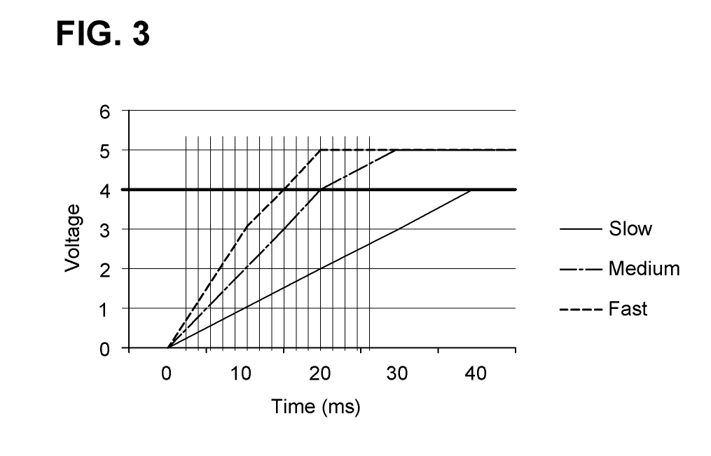

The speed estimator 36 inputs the signal from the capacitive sensor 16 and initiates calculating (or estimating) a speed of the contact surface 12 pushed by the user upon receiving the signal. The speed estimator 36 calculates the speed of the contact surface 12 based on the voltage output from the optical sensor 14. FIG. 3 shows three exemplar line-graphs each indicating a change in voltage output from the optical sensor 14 over time. The first line-graph represented by the solid line shows a change in voltage when a user pushes the contact surface 12 slowly. The second line-graph represented by the dashed line shows a change in voltage when a user pushes the contact surface 12 quickly. The third line-graph represented by the dash-dotted line shows a change in voltage when a user pushes the contact surface 12 at a medium speed between the speeds in the first graph and the second graph. Time 0 is a timing at which the ECU 20 inputs the signal from the capacitive sensor 16 (i.e., at the time a user starts pushing the contact surface 12).

The speed estimator 36 calculates the speed of the contact surface 12 by calculating a slope of the graph on average between a specified period. For example, the speed estimator 36 calculates an average value of the slope from Time 0 until the voltage reaches a specified value (e.g., 4V). When the speed estimator 36 calculates the speed of the contact surface 12, the speed estimator 36 outputs the speed calculated to the microprocessor 38.

The microprocessor 38 is configured to control operation of the solenoid 18 according to the speed calculated by the speed estimator 36. More specifically, the microprocessor 38 controls timing of both energization and de-energization of the solenoid 18. In other words, the microprocessor 38 controls time period for energizing the solenoid 18 (hereinafter, referred to as “energizing period (activation time)”) by controlling timing of energization and de-energization of the solenoid 18. In this embodiment, the microprocessor 38 increases the energizing period, as the speed calculated by the speed estimator 36 increases.

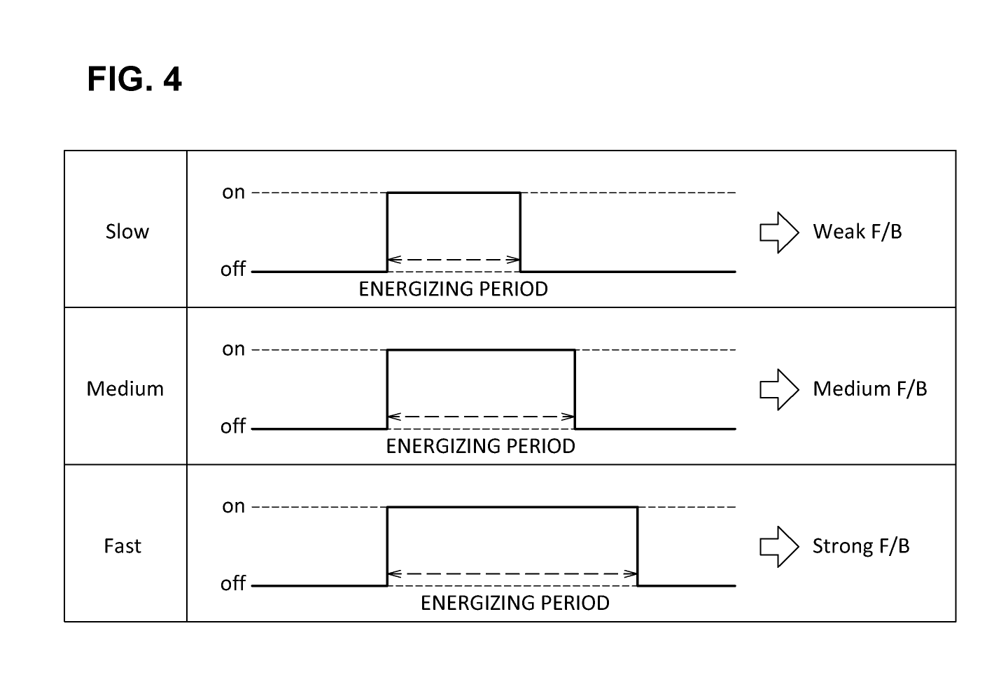

FIG. 4 shows one example of timing charts for energization/de-energization of the solenoid 18. As shown in the timing charts, when a user pushes the contact surface 12 slowly, or softly, (see the upper chart), the solenoid 18 is energized for a short time period (e.g., 2 ms) shorter than the other two charts. Thus, the plunger 24 moves a short distance and the pressing portion 28 pushes the contact surface 12 toward the second side such a short distance. As a result, the user feels weak feedback from the contact surface 12 through the user's finger in response to the weak push by the user.

In contrast, when a user pushes the contact surface 12 quickly, or strongly (see the lower chart), the solenoid 18 is energized for a long time period (e.g., 10 ms) longer than the other two charts. Thus, the plunger 24 moves a relatively longer distance and the pressing portion 28 pushes the contact surface 12 toward the first side such a longer distance. As a result, the user feels strong feedback from the contact surface 12 through the user's finger in response to the strong push by the user.

Furthermore, if a user pushes the contact surface 12 at a medium speed, the solenoid 18 is energized for a medium time period (e.g., 5 ms) between the other two charts. Thus, the plunger 24 moves a medium distance and the pressing portion 28 pushes the contact surface 12 toward the first side such a medium distance. As a result, the user feels medium feedback from the contact surface 12 through the user's finger in response to the medium push by the user.

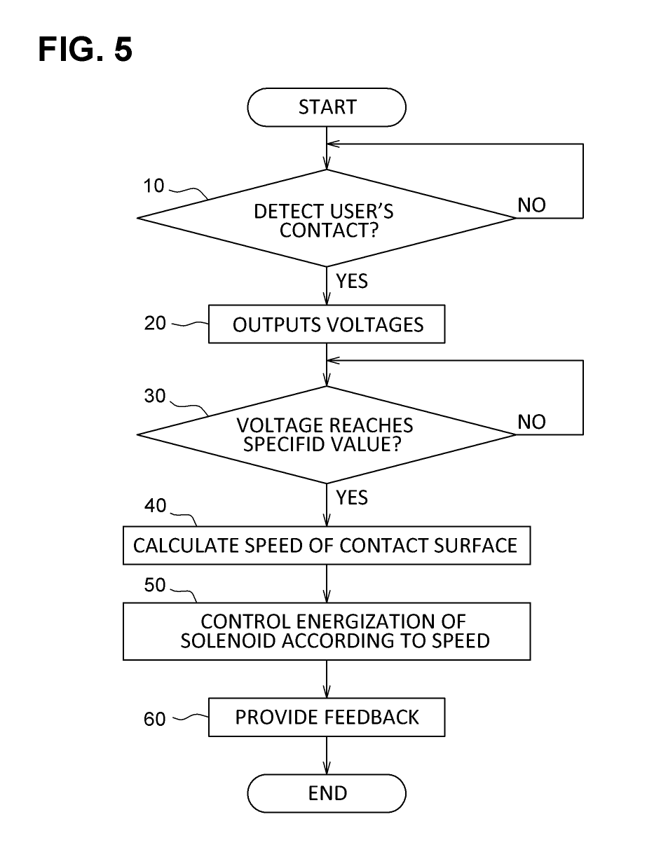

Next, operation of the dynamic feedback system 10 according to the present embodiment will be described with reference to the flowchart shown in FIG. 5. The dynamic feedback system 10 (i.e., the ECU 20) repeatedly performs the operation shown in the flowchart of FIG. 5.

When a user touches and pushes the contact surface 12 toward the first side, the capacitive sensor 16 detects the contact at Step 10. Then, the capacitive sensor 16 sends the signal indicative of the contact of the user to the ECU 20 (i.e., the speed estimator 36). Upon detection of the contact, the speed estimator 36 starts monitoring the voltage from the optical sensor 14 with respect to the elapsed time. The optical sensor 14 detects the distance d to the contact surface 12 and outputs voltages according to the distance d of the contact surface 12 to the speed estimator 36 at Step 20.

The speed estimator 36 monitors whether the voltage from the optical sensor 14 reaches the specified value (e.g., 4V) at Step 30. Then, when the voltage output from the optical sensor 14 reaches the specified value (Step 30: YES), the speed estimator 36 calculates, at Step 40, the speed of the contact surface 12 by obtaining an average value of the slope of the voltage between Time=0 and the timing at which the voltage reaches the specified value.

Once the speed of the contact surface 12 is calculated by the speed estimator 36, the microprocessor 38 controls the solenoid 18 according to the speed at Step 50. As shown in FIG. 4, the microprocessor 38 decreases the energizing period when the speed of the contact surface 12 is low. As a result, the plunger 24 moves a relatively short distance and the contact surface 12 is pushed by the pressing portion 28 toward the second side such a shorter distance. Accordingly, the user feels weak feedback from the contact surface 12 through the user's finger in response to the slow push by the user (Step 60).

In contrast, when the speed estimator 36 calculates a relatively high speed of the contact surface 12, the microprocessor 38 increases the energizing period as compared to the case where the speed calculated by the speed estimator 36 is low. Then, the plunger 24 moves a relatively longer distance and the contact surface 12 is pushed by the pressing portion 28 toward the second side such a longer distance. As a result, the user feels strong feedback from the contact surface 12 through the user's finger in response to the quick push by the user.

Furthermore, when the speed estimator 36 calculates a medium speed of the contact surface 12, the microprocessor 38 sets a medium energizing period between the energizing periods for the above-two cases. The plunger 24 moves a medium distance and the contact surface 12 is pushed by the pressing portion 28 toward the second side such a medium distance. As a result, the user feels medium feedback from the contact surface 12 through the user's finger in response to the medium push by the user.

As described above, the dynamic feedback system 10 according to the present embodiment can provide a user with feedback according to the speed of the contact surface 12 pushed by the user. Therefore, the user can feel natural reaction from the interface device through the user's finger.

### Other Embodiments

In the above-described embodiment, the microprocessor 38 changes the energizing period according to the speed of the contact surface 12. However, any pattern of energizing the solenoid 18 may be used according to the speed of the contact surface 12. For example, the microprocessor 38 may change energizing pattern of the solenoid 18 such that the contact surface 12 vibrates at different frequencies. More specifically, if a user pushes the contact surface 12 slowly, the microprocessor 38 controls energization of the solenoid 18 such that the contact surface 12 vibrates at a low frequency, whereas if a user pushes the contact surface 12 quickly, the microprocessor 38 controls energization of the solenoid 18 such that the contact surface 12 vibrates at a high frequency.

Any feedback pattern may be used for the dynamic feedback system 10. For example, when the dynamic feedback system 10 is applied to a control panel of an air-conditioning system, and the contact surface 12 is used to serve a push button to set a temperature, the microprocessor 38 may control the TFT display to change the image of the temperature (i.e., the number indicative of a temperature) displayed on the control panel according to the speed of the contact surface 12. In this case, the TFT display serves as a feedback generator in the present disclosure. Specifically, when a user pushes the contact surface 12 slowly, the microprocessor 38 controls the TFT display to change the image of the temperature step by step, while if a user pushes the contact surface 12 quickly, the microprocessor 38 controls the TFT display to change the image of the temperature quickly and continuously.

Alternatively, the dynamic feedback system 10 may provide audible feedback. In this case, a speaker may serve as a feedback generator. For example, when a user pushes the contact surface 12 quickly, the microprocessor 38 may control the speaker to generate a softer sound to the user.

In the above-described embodiment, the speed estimator 36 calculates the speed of the contact surface 12 based on the voltage output from the optical sensor 14, i.e., the speed of the contact surface 12 is indirectly calculated. In other words, the combination of the optical sensor 14 and the speed estimator 36 serve as a speed detector of the present disclosure that detects the speed of the contact surface 12. Alternatively, a speed sensor that is capable of directly detecting a speed of an object may be used. In this case, since the speed of the contact surface 12 is directly obtained by the speed sensor, the speed estimator 36 may be eliminated.

In the above-described embodiment, the contact surface 12 constitutes a portion of the TFT display. Alternatively, the contact surface 12 may be formed of a glass, a capacitive film, a resistive film, an acrylic, a metallic, a PCB, a conductive paint, or piezoelectric surfaces.

In the above embodiments, the capacitive sensor 16 is used as a touch sensor. However, other types of sensors may be used as the touch sensor. For example, a resistive sensor, an inductive sensor, a pressure (piezoelectric) sensor, a strain sensor, a force sensor, an infrared sensor, or a monochromatic sensor may be used as a touch sensor.

In the above embodiments, the optical sensor 14 is used as a position sensor (or a speed sensor). However, other types of sensors may be used as the position sensor. For example, a force, a pressure (piezoelectric) sensor, a strain sensor, an infrared sensor, or a monochromatic sensor may be used as a position sensor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

1. A dynamic feedback system for an interface device, the dynamic feedback system comprising:
a contact surface configured to move toward a first side of the contact surface when a pressure is exerted upon the contact surface by a user;
a speed detector configured to detect a speed of the contact surface moving toward the first side;
a feedback generator configured to provide feedback to the user, and
a controller configured to control the feedback generator according to the speed of the contact surface detected by the speed detector, wherein
the feedback generator is an actuator, and
the actuator applies a force, as the feedback, to the contact surface toward a second side of the contact surface that is opposite to the first side, wherein
the actuator is a solenoid,
the solenoid includes a plunger that presses the contact surface toward the second side when the solenoid is energized,
the controller configured to energize the solenoid for a first energizing period to have the plunger press the contact surface for a first distance when the speed detector detects a first speed of the contact surface, and
the controller configured to energize the solenoid for a second energizing period longer than the first energizing period to have the plunger press the contact surface for a second distance when the speed detector detects a second speed of the contact surface that is greater than the first speed.

2-3. (canceled)

4. The dynamic feedback system according to claim 1, wherein
the speed detector includes a position sensor and a speed estimator,
the position sensor is configured to detect a position of the contact surface and outputs a signal according to the position detected to the speed estimator, and
the speed estimator calculates the speed of the contact surface based on the signal from the position sensor.

5. The dynamic feedback system according to claim 4, wherein
the position sensor is an optical sensor,
the optical sensor outputs a voltage as the signal according to the position of the contact surface to the speed estimator, and
the speed estimator calculates the speed of the contact surface based on the voltage from the optical sensor.

6. The dynamic feedback system according to claim 4, further comprising
a touch sensor attached to the contact surface to detect contact of the user, and
the speed estimator calculates the speed of the contact surface upon detecting contact of the user by the touch sensor.

7. (canceled)

8. A method for providing dynamic feedback, the method comprising:
moving, by a pressure exerted upon a contact surface by a user, the contact surface toward a first side of the contact surface;
detecting, with a speed detector, a speed of the contact surface moving toward the first side; and
controlling, with a controller, a feedback generator to provide feedback to the user according to the speed of the contract surface detected by the speed detector wherein
the feedback generator is an actuator, and
the method further comprises applying a force as the feedback, with the actuator, to the contact surface toward a second side of the contact surface that is opposite to the first side,
the actuator is a solenoid, and
the solenoid includes a plunger that presses the contact surface when the solenoid is energized, wherein
the method further comprises:
energizing, by the controller, the solenoid for a first energizing period to have the plunger press the contact surface for a first distance when the speed detector detects a first speed of the contact surface, and
energizing, by the controller, the solenoid for a second energizing period longer than the first energizing period to have the plunger press the contact surface for a second distance when the speed detector detects a second speed of the contact surface that is greater than the first speed.

9-10. (canceled)

11. The method according to claim 8, wherein
the speed detector includes a position sensor and a speed estimator, and
the method further comprises:
detecting, with the position sensor, a position of the speed estimator, and
calculating, with the speed estimator, the speed of the contact surface based on the signal from the position sensor.

12. The method according to claim 11, wherein
the position sensor is an optical sensor, and
the method further comprises
outputting, with the optical sensor, a voltage according to the position of the contact surface to the speed estimator, and
calculating, with the speed estimator, the speed of the contact surface based on the voltage from the optical sensor.

13. The method according to claim 11, further comprising
detecting, with a touch sensor attached to the contact surface, contact of the user, and
calculating, with the speed estimator, the speed of the contact surface upon detecting the contact of the user by the touch sensor.

14. (canceled)
